(19) United States
(12) Patent Application Publication
(10) Pub. No.: US 2007/0026265 A1
(43) Pub. Date: Feb. 1, 2007

(54) Patterned substrate having patterns of protrusions and recesses, method of manufacturing the same, magnetic recording media, and magnetic recording apparatus

(75) Inventors: Masatoshi Sakurai, Tokyo (JP); Akira Kikitsu, Yokohama-shi (JP); Masahiro Oka, Ichihara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); SHOW A DENKO K.K., Tokyo (JP)

(21) Appl. No.: 11/493,652

(22) Filed: Jul. 27, 2006

(30) Foreign Application Priority Data
Jul. 27, 2005 (JP) 2005-217470

(51) Int. Cl. G11B 5/706; B05D 3/12

(52) U.S. Cl. 428/848.3; 428/848.5; 427/355

(57) ABSTRACT

According to one embodiment, a patterned substrate used for a magnetic recording media having discrete tracks includes patterns of protrusions and recesses processed thereon, and a texture structure formed on each of the recesses.

### CROSS-REFERENCE TO RELATED APPLICATIONS

This application is based upon and claims the benefit of priority from Japanese Patent Application No. 2005-217470, filed Jul. 27, 2005, the entire contents of which are incorporated herein by reference.

### BACKGROUND

1. Field

One embodiment of the present invention relates to the a patterned substrate having patterns of protrusions and recesses and used for discrete track media, a method of manufacturing the patterned substrate, magnetic recording media using the patterned substrate (substrate processing type discrete track media), and a magnetic recording apparatus using the magnetic recording media.

2. Description of the Related Art

Recent magnetic recording media are further demanded to have an increased density and an improved signal-to-noise ratio (SNR). To improve the density of magnetic recording media, a discrete track structure is effectively employed in which adjacent tracks are separated from each other by a separating groove or a nonmagnetic material.

It is also known that a process of subjecting a substrate to texturing is effective for improving the SNR. The reason is as follows. When an underlayer is deposited on a flat substrate, the material of the underlayer is randomly oriented and a magnetic recording layer is deposited on the underlayer. Thus, magnetic flux may be disturbed in an area where regions having different orientations are adjacent to each other in the underlayer, which may cause reproducing noise. In contrast, when a texture structure with orientation is provided on the substrate, a soft magnetic underlayer deposited on the substrate can be properly oriented. This makes it possible to suppress noise that may occur between regions with different orientations.

A magnetic recording media has hitherto been known in which a texture structure is formed to improve the SNR (Jpn. Pat. Appln. KOKAI Publication No. 2003-109213). However, this magnetic recording media is not discrete track media and thus the recording density thereof cannot be improved. Further, the magnetic recording media requires texturing for each disk, leading to increased costs.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view schematically showing magnetic recording media (discrete track media) according to an embodiment of the present invention;

FIG. 2 is an enlarged plan view showing an example of data and servo regions in the magnetic recording media in FIG. 1;

FIG. 3 is a cross-sectional view showing an example of a patterned substrate having patterns of protrusions and recesses according to an embodiment of the present invention;

FIG. 4 is a cross-sectional view showing another example of a patterned substrate having patterns of protrusions and recesses according to an embodiment of the present invention;

FIG. 5 is a cross-sectional view showing yet another example of a patterned substrate having patterns of protrusions and recesses according to an embodiment of the present invention;

FIG. 6 is a cross-sectional view showing an example of magnetic recording media according to an embodiment of the present invention;

FIG. 7 is a perspective view showing an example of a magnetic recording apparatus according to an embodiment of the present invention;

FIGS. 8A, 8B, 8C, 8D, 8E, 8F, 8G, 8H, 8I, and 8J are cross-sectional views showing a method of manufacturing a patterned substrate having patterns of protrusions and recesses in Example 1;

FIGS. 9A, 9B, 9C, 9D, 9E, 9F, 9G, 9H, 9I, and 9J are cross-sectional views showing a method of manufacturing a patterned substrate having patterns of protrusions and recesses in Example 2; and

FIGS. 10A, 10B, 10C, and 10D are cross-sectional views showing a method of manufacturing magnetic recording media according to an embodiment of the present invention.

### DETAILED DESCRIPTION

Various embodiments according to the invention will be described hereinafter with reference to the accompanying drawings. In general, according to one embodiment of the present invention, there is provided a patterned substrate used for a magnetic recording media having discrete tracks, comprising: patterns of protrusions and recesses processed thereon, and a texture structure formed on each of the recesses.

According to another embodiment of the present invention, there is provided a method of manufacturing a patterned substrate having patterns of protrusions and recesses, comprising: forming a texture structure on each of the protrusions on a stamper having patterns of protrusions and recesses; pressing the stamper against an imprint resist applied to a substrate to transfer the patterns of protrusions and recesses of the stamper and the texture structures on the protrusions to the imprint resist; and etching the substrate using the imprint resist as a mask, to which the patterns and texture structures have been transferred, to form a patterned substrate having the patterns of protrusions and recesses formed on a surface thereof with the texture structure formed on each of the recesses.

According to still another embodiment of the present invention, there is provided a method of manufacturing a patterned substrate having patterns of protrusions and recesses, comprising: forming a texture structure on a surface of a master; applying a resist to the master, drawing patterns of protrusions and recesses on the resist, and developing the resist to form a resist pattern having the protrusions and recesses; etching the master using the resist pattern as a mask to form a patterned master having the patterns of protrusions and recesses formed thereon with the texture structure formed on each of the protrusions and recesses; producing a first stamper from the master having the protrusions and recesses and producing a second stamper from the first stamper; pressing the second stamper against an imprint resist applied to a substrate to transfer the patterns of protrusions and recesses of the second stamper and the texture structures on the protrusions and recesses to the imprint resist; and etching the substrate using the imprint resist as a mask, to which the patterns and texture structures have been transferred, to form a patterned substrate having the patterns of protrusions and recesses formed on a surface thereof with the texture structure formed on each of the protrusions and recesses.

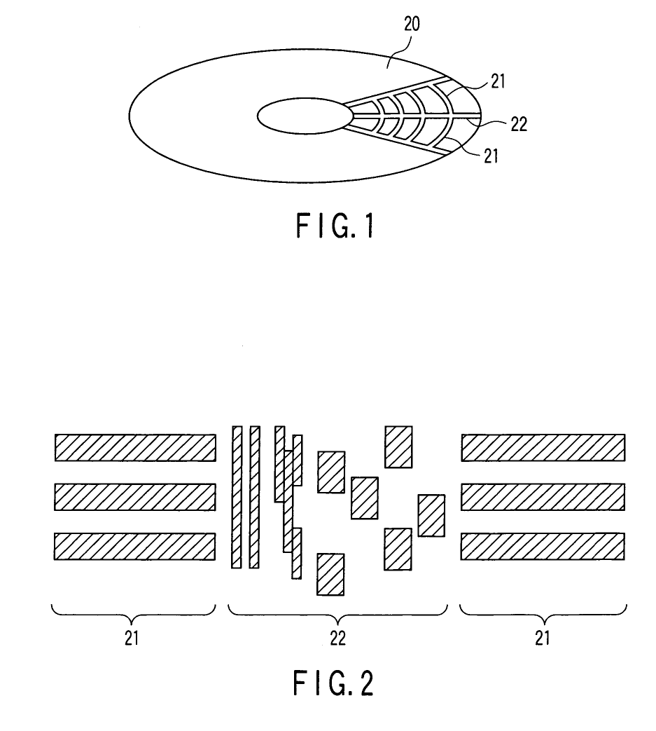

FIG. 1 is a perspective view schematically showing a magnetic recording media (discrete track media) according to an embodiment of the present invention. A surface of magnetic recording media 20 has data regions 21 to which user data is written, and servo regions 22 including preambles, addresses, burst signals, and the like used for tracking or data access control. Tracks are concentrically arranged in each of the data regions 21. Each of the servo regions 22 is formed radially on the media. FIG. 1 schematically shows the arrangement of these regions in a part of a disk surface.

FIG. 2 is an enlarged plan view showing an example of the data and servo regions in the magnetic recording media in FIG. 1. In this figure, only protrusions of a magnetic thin film are hatched. In the present invention, a magnetic thin film with patterns of protrusions and recesses such as those shown in FIG. 2 is formed by pre-forming the patterns of protrusions and recesses on the substrate and depositing an underlayer and a magnetic thin film on the patterns of protrusions and recesses. In the data region 21 in FIG. 2, tracks are formed of patterns of the magnetic thin film deposited on the protrusions formed circumferentially on the substrate surface. The tracks are separated from one another by magnetic thin films (separating regions) deposited on recesses formed along the circumferentially on the substrate surface. In the servo region 22 in FIG. 2, servo patterns are formed which consists of the patterns of the magnetic thin film deposited on the protrusions of the substrate surface. The servo patterns are separated from one another by the magnetic thin film deposited on the recesses in the substrate surface. The servo patterns in FIG. 2 are similar to those in current magnetic recording apparatuses.

The patterned substrate according to an embodiment of the present invention has a texture structure formed at least on the recesses. The texture structure consists of grooves formed by roughening the surface using abrasive grains, and a group of replicas of the groove structure which is made using the above groove structure. Each groove has orientation. The orientations of the grooves constituting the texture structure may be concentric or radial. However, the grooves have only to extend in almost the same direction and need not be parallel to one another but may cross one another. Further, the grooves need not have the same configuration but may have random widths and depths. The grooves are thus different from those obtained by lithography and having the same period, width, and depth. The depth of recesses of the texture structure is preferably between about 0.5 and 10 nm. The interval between the adjacent grooves is preferably between about 5 and 100 nm. Ra (arithmetic average of roughness) is used to define the depth of surface roughness of the texture. Ra denotes the average value of absolute deviations from an average line for the protrusions and recesses in a cross section of an objective surface.

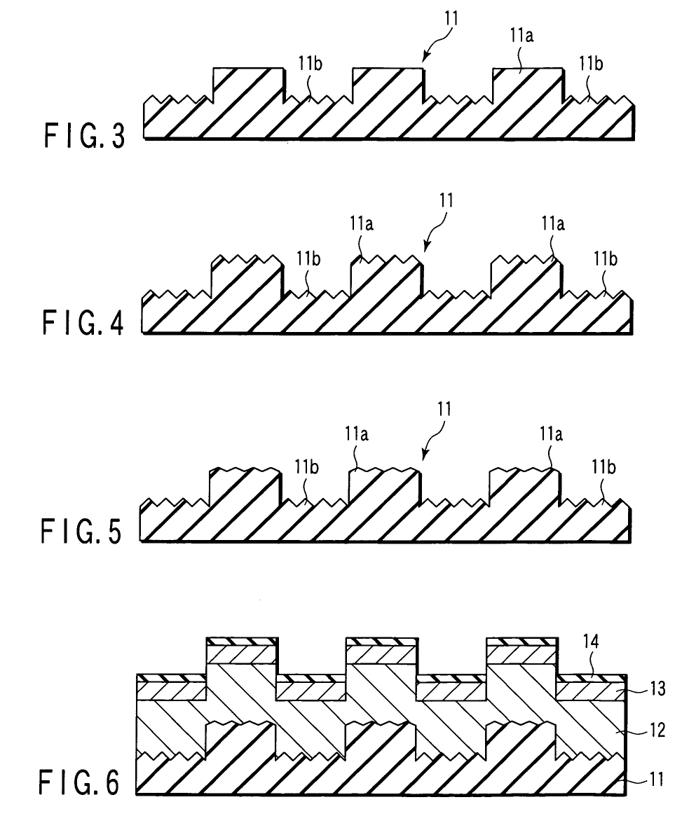

FIG. 3 shows a cross-sectional view of a patterned substrate having patterns of protrusions and recesses according to an embodiment of the present invention. A patterned substrate 11 have protrusions 11a and recesses 11b formed on the surface thereof. A texture structure is formed only on the recesses 11b and not on the protrusions 11a.

FIG. 4 shows a cross-sectional view of a patterned substrate having patterns of protrusions and recesses according to another embodiment of the present invention. The patterned substrate 11 has a texture structure formed not only on the recesses 11b but also on the protrusions 11a. The texture structures on the recesses 11b and protrusions 11a are effective in aligning the orientation of the underlayer even if directions are different between the texture structures. However, the same orientation between the protrusions and recesses is preferable for making the orientation of the underlayer more uniform.

FIG. 5 shows a cross-sectional view of a patterned substrate having patterns of protrusions and recesses according to yet another embodiment of the present invention. The patterned substrate 11 also has a texture structure formed on the recesses 11b and protrusions 11a. However, the texture structure on the recess 11a has a larger Ra than that on the protrusion 11b.

While the magnetic recording media is being driven, a read/write head flies over the media. Accordingly, the smaller Ra of the protrusions lying opposite the read/write head reduces the flying height of the head from the media, which is preferable for read/write. However, for the protrusions, an Ra more than zero is more preferable than an Ra of zero in control of orientation of the underlayer. Consequently, when the texture structure of the recesses 11a has a large Ra than that of the protrusions 11b, the flying height of the read/write head can be reduced as well as the orientation of the underlayer can be made uniform.

FIG. 6 shows a cross-sectional view of an example of a magnetic recording media (discrete track media) according to an embodiment of the present invention. The magnetic recording media has an underlayer 12, a magnetic recording layer 13, and a protective layer 14 deposited on the patterned substrate 11 having patterns of protrusions and recesses shown in FIG. 5.

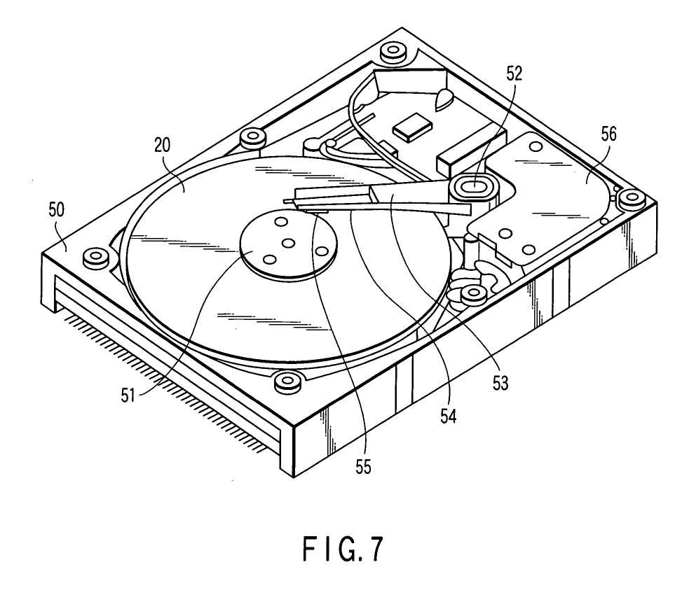

FIG. 7 shows a perspective view of a magnetic recording apparatus according to an embodiment of the present invention. The magnetic recording apparatus comprises magnetic recording media 20, a spindle motor 51 that rotates the magnetic recording media, a head slider 55 including a read head using a giant magnetoresistive (GMR) element, a head suspension assembly (suspension 54 and actuator arm 53) that supports the head slider 55, a voice coil motor (VCM) 56, and a circuit board all of which are provided inside a chassis 50.

The magnetic recording media 20 is mounted on the spindle motor 51 and rotated. Various digital data are recorded on the magnetic recording media on the basis of a perpendicular or longitudinal magnetic recording scheme. A magnetic head incorporated in the head slider 55 is what is called a composite head. As the write head, a single pole head is used for perpendicular magnetic recording, whereas a ring head is used for longitudinal magnetic recording. A write head structure based on any other scheme may be used. The read head may be a GMR element described above, a TMR element, or an element based on any other scheme. The read head has a pair of magnetic shields sandwiching the read element therebetween.

The suspension 54 is held at one end of the actuator arm 53 to support the head slider 55 opposite a recording surface of the magnetic recording media 20. The actuator arm 53 is attached to a pivot 52. The voice coil motor (VCM) 56 is provided at the other end of the actuator arm 53 to serve as an actuator. The voice coil motor (VCR) 56 actuates the head suspension assembly to position the magnetic head at an arbitrary radial position on the magnetic recording media 20. The circuit board comprises a head IC to generate signals for driving the voice coil motor (VCM), control signals for controlling read and write operations performed by the magnetic head, and the like.

### EXAMPLES

### Example 1

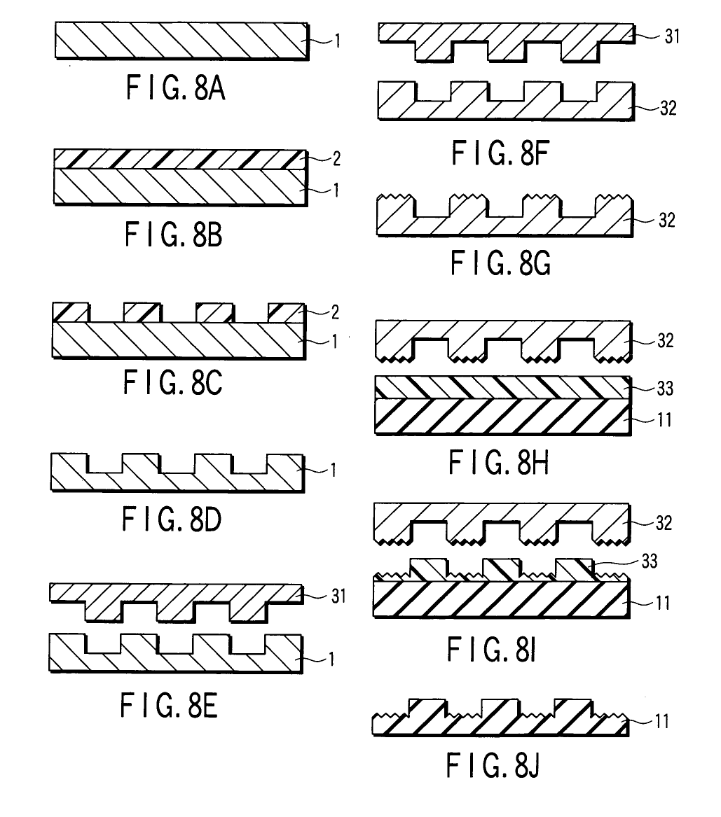

With reference to FIGS. 8A, 8B, 8C, 8D, 8E, 8F, 8G, 8H, 8I, and 8J, description will be given of an example of a method of manufacturing a patterned substrate having patterns of protrusions and recesses. The method in the present example is divided into (A) master preparation, (B) resist application, (C) drawing and development of patterns of protrusions and recesses, (D) etching of the master, (E) father stamper electroforming, (F) son stamper electroforming, (G) texturing, (H) resist application to a substrate, (I) imprinting, and (J) etching of the substrate. These steps will be described.

(A) As a master 1, a silicon wafer with a diameter of 6 inches and a thickness of 1.0 mm was prepared. (B) A resist sensitive to an electron beam was spin-coated on the master 1 to a thickness of 70 nm. (C) Using an electron beam drawing apparatus, the resist 2 was subjected to pattern exposure. The patterns included tracks and servo marks. The master 1 was immersed in a developer to develop the resist 2. The master 1 was immersed and rinsed in a rinse liquid. The master 1 was dried by air blowing to form a resist pattern with recesses at a depth of 70 nm. (D) The master 1 was etched with CF₄ gas using the resist pattern as a mask. The remaining resist was ashed with oxygen. The depth of the recess on the master was 70 nm.

(E) An Ni conductive film with a thickness of 20 nm was deposited on a surface of the resultant master having protrusions and recesses by sputtering. Electroforming was subsequently carried out to form an Ni electroforming film with a thickness of 0.6 mm on the Ni conductive film. The Ni electroforming film together with the Ni conductive film was stripped off from the master to obtain a father stamper 31. (F) A process similar to that described above was executed on the father stamper 31 to obtain a son stamper 32. The depth of the recess on the son stamper was 70 nm.

(G) Texturing was performed on the protrusions of the son stamper 32 with a tape texturing machine. Tapes were placed so as to sandwich the son stamper 32 along the radius thereof. While the tapes moving in the radial direction were supplied with an abrasive containing diamond grains with an average size of 100 nm, the sun stamper 32 was rotated to cause friction. A texture structure was thus formed on the protrusions of the son stamper 32. Surface observation of the sun stamper 32 with an atomic force microscopic (AFM) showed that a texture structure formed on each of the protrusions of the son stamper 32 by texturing. The texture structure had grooves aligned in the cross-track direction. The protrusions had Ra of 1.0 nm. No texture pattern was observed on the recesses.

(H) On the other hand, an imprint resist 33 with a thickness of 100 nm was applied to a glass substrate 11 for magnetic recording media. (I) The son stamper 32 was pressed against the imprint resist 33 by nano-imprint process to transfer the patterns of protrusions and recesses (including textures) of the son pattern 32 to the imprint resist 33. (J) The glass substrate 11 was etched with CF₄ gas using the patterns of protrusions and recesses on the imprint resist 22 as a mask to which the patterns had been transferred. The remaining resist was then ashed with oxygen. A glass substrate 12 was thus obtained which had patterns of protrusions and recesses on the surface thereof with the texture structure on each of the recesses. The depth of the recess on the substrate was 20 nm. The texture structure on the recess had Ra of 0.9 nm. On the other hand, no texture structures were observed on the protrusions, which were thus flat.

### Example 2

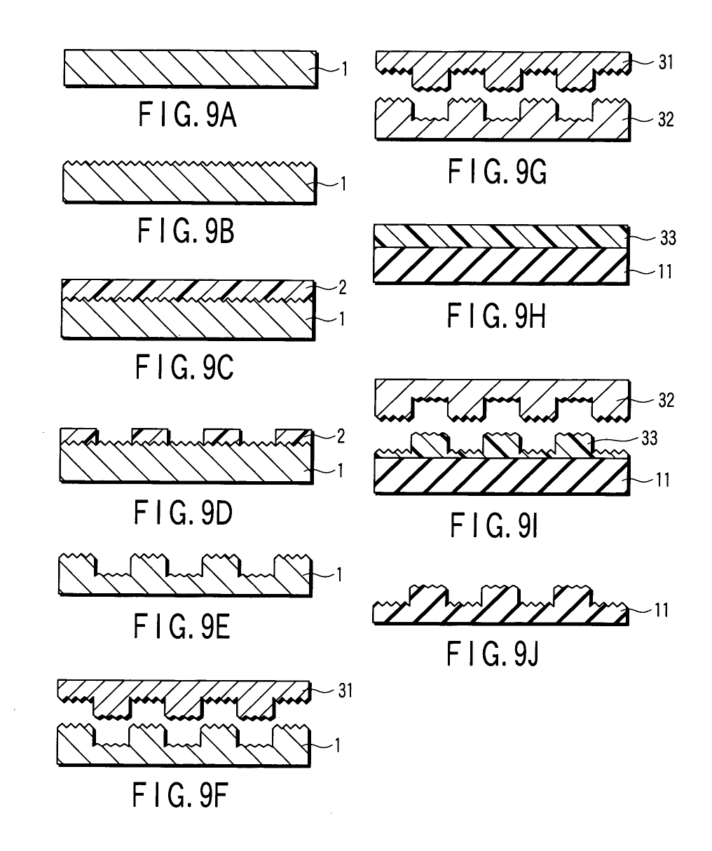

With reference to FIGS. 9A, 9B, 9C, 9D, 9E, 9F, 9G, 9H, 9I, and 9J, description will be given of another example of a method of manufacturing a patterned substrate having patterns of protrusions and recesses. The method in the present example is divided into (A) master preparation, (B) texturing, (C) resist application, (D) drawing and development of patterns of protrusions and recesses, (E) etching of the master, (F) father stamper electroforming, (G) son stamper electroforming, (H) resist application to a substrate, (I) imprinting, and (J) etching of the substrate. These steps will be described below.

(A) As a master 1, a silicon wafer with a diameter of 6 inches and a thickness of 1.0 mm was prepared. (B) Texturing was performed on the master 1 with a tape texturing machine. Tapes were placed so as to sandwich the son stamper 32 along the radius thereof. While the tapes moving in the radial direction were supplied with an abrasive containing diamond grains with an average size of 100 nm, the master 1 was rotated to cause friction. A texture structure was thus formed on the surface of the master 1. After washing with water, surface observation of the master 1 with AFM showed a texture structure having grooves aligned in the cross-track direction. The grooves had Ra of 1.0 nm. (C) A resist sensitive to an electron beam was spin-coated on the master 1 to a thickness of 70 nm. (D) Using an electron beam drawing apparatus, the resist 2 was subjected to pattern exposure. The pattern included tracks and servo marks. The master 1 was immersed in a developer to develop the resist 2. The master 1 was immersed and rinsed in a rinse liquid. The master 1 was dried by air blowing to form a resist pattern with recesses at a depth of 70 nm. It was confirmed with AFM that the texture structure was exposed from the exposed surface of the master in the recesses of the resist pattern.

(E) The master 1 was etched with CF₄ gas using the resist pattern as a mask. The remaining resist was ashed with oxygen. The surface roughness of the texture structure on each recess of the master 1 decreased during etching, by which Ra decreased to 0.5 nm. The surface roughness of the texture structure on each protrusion of the master 1 did not decrease, with Ra remained at 1.0 nm. The depth of the recess on the master was 70 nm.

(F) An Ni conductive film with a thickness of 20 nm was deposited on a surface of the resultant master having protrusions and recesses by sputtering. Electroforming was subsequently carried out to form an Ni electroforming film with a thickness of 0.6 mm on the Ni conductive film. The Ni electroforming film together with the Ni conductive film was stripped off from the master to obtain a father stamper 31. (G) A process similar to that described above was executed on the father stamper 31 to obtain a son stamper 32. As to the son stamper 32, the texture structure of each recess had Ra of 0.5 nm, while the texture structure of each protrusion had Ra of 1.0 nm. The depth of the recess on the stamper was 70 nm.

(H) On the other hand, an imprint resist 33 with a thickness of 100 nm was applied to a glass substrate 11 for magnetic recording media. (I) The son stamper 32 was pressed against the imprint resist 33 by nano-imprint process to transfer the patterns of protrusions and recesses (including textures) of the son pattern 32 to the imprint resist 33. (J) The glass substrate 11 was etched with CF₄ gas using the patterns of protrusions and recesses on the imprint resist 22 as a mask to which the patterns had been transferred. The remaining resist was then ashed with oxygen. A glass substrate 12 was thus obtained which had patterns of protrusions and recesses on the surface thereof with the texture structure on each of the recesses. The depth of the recess on the substrate was 20 nm. The texture structure on the recess had Ra of 0.9 nm. The texture structure on the protrusion had Ra of 0.4 nm.

(Method for Manufacturing Magnetic Recording Media according to Examples)

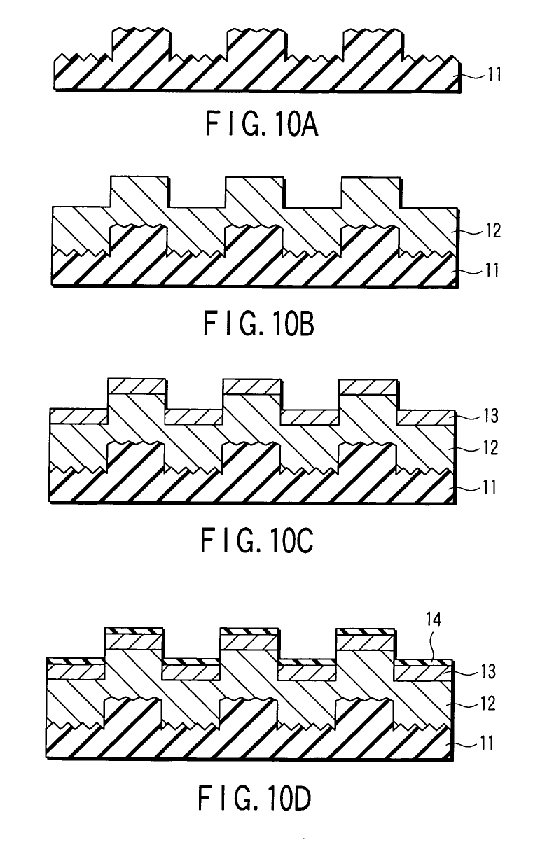

With reference to FIGS. 10A, 10B, 10C, and 10D, description will be given of an example of a method of manufacturing magnetic recording media according to an embodiment of the present invention. In these figures, the patterned substrate 11 is obtained according to Example 2. However, it is possible to use the patterned substrate 11 which is obtained according to Example 1.

A magnetic recording media was manufactured by preparing the patterned substrate 11(A), depositing the underlayer 12(B), depositing the magnetic recording layer 13(C), and depositing the protective film 14(D).

In the present example, the following three types of magnetic recording media were produced.

(a) CoZrNb soft magnetic underlayer 100 nm/CoB 5 nm/Ta 5 nm/Pd 5 nm/Ru 10 nm/CoCrPt—SiO₂ recording layer 15 nm/C protective layer 4 nm. In this media, the soft magnetic underlayer had a structure in which two CoZrNb layers were antiferromagnetically coupled.

(b) FeTaN soft underlayer 80 nm/Ti 5 nm/Pd 10 nm/[Co 0.3 nm/Pd 0.9 nm]₂₀ recording layer/C protective layer 4 nm. In this media, the recording layer was a so-called magnetic artificial lattice film obtained by alternately stacking 0.3 nm of Co and 0.9 nm of Pd twenty times.

(c) NiAl 60 nm/Cr 10 nm/CrMo 20 nm/CoCrPtTa recording layer 15 nm/C protective layer 4 nm.

The media (a) and (b) are perpendicular magnetic recording media with the easy axis of magnetization oriented perpendicularly to the film plane. The media (c) is a longitudinal magnetic recording media with the easy axis of magnetization oriented parallel to the film surface.

(Magnetic Recording Media in Comparative Example)

As a comparative example, a perpendicular discrete media (a) was produced by a method similar to that in Example 1 except for the texturing.

The magnetic recording media were evaluated for electromagnetic conversion characteristics and overwrite (OW) characteristics. The evaluations were carried out as follows.

Electromagnetic Conversion Characteristics

Read/write (R/W) tests were conducted on the magnetic recording media using a single pole head to write signals to the media and using a GMR head to read signals from the media. Measurements were made at the fixed position of radius of 20 nm with the disk rotated at 4,200 rpm. High-frequency signals at 552 kFCI and low-frequency signals at 92 kFCI were measured, with the respective outputs shown. The media SNR (S/Nm) was evaluated by using, as an S value, the half of a pp value (difference between the maximum positive and negative values) in a magnetization reversal of isolated waveform at 10 kFCI and, as an Nm value, the rms (root mean square) value of noise at 400 kFCI.

Overwrite (OW) Characteristics

The overwrite (OW) characteristics were determined by overwriting the signals at 400 kFCI with the signals at 92 kFCI and comparing a signal output obtained before overwrite with a signal output of signals not erased after overwrite.

Table 1 shows the evaluations. Table 1 shows that more excellent SNR and OW characteristics are provided by the magnetic recording media in Examples manufactured using patterned substrates having patterns of protrusions and recesses with a texture structure formed at least on each recess, than by the magnetic recording media in Comparative Example.

TABLE 1

| | High-frequency | Low-frequency | S/Nm | OW |
|---|---|---|---|---|
| | output (mV) | output (mV) | (dB) | (dB) |
| Example 1 (a) | 1.07 | 3.05 | 24.4 | 47.9 |
| Example 1 (b) | 1.08 | 3.11 | 24.9 | 48.7 |
| Example 1 (c) | 1.06 | 3.03 | 23.6 | 47.0 |
| Example 2 (a) | 1.08 | 3.10 | 24.8 | 48.2 |
| Example 2 (b) | 1.10 | 3.17 | 25.4 | 49.0 |
| Example 2 (c) | 1.07 | 3.02 | 24.0 | 47.3 |
| Comparative | 0.95 | 2.89 | 21.9 | 44.5 |
| Example | | | | |

It had also been found that flying stability of the slider could be achieved when patterns of protrusions and recesses are formed on the media, and in the case where a texture structure is formed on each recess, whereas no texture structure is formed on each protrusion, or in the case where the texture structure on the protrusion is set to have a lower surface roughness Ra than the texture structure on the recess.

Description will be given of materials used for the layers in a magnetic recording media according to an embodiment of the present invention as well as the stacked structure of each layer.

The substrate may be, for example, a glass substrate, an Al-based alloy substrate, a ceramic substrate, a carbon substrate, or a Si monocrystalline substrate. The glass substrate may be composed of amorphous glass or crystallized glass. The amorphous glass may be soda lime glass, alumino silicate glass, or the like. The crystallized glass may be lithium-based crystallized glass or the like. The ceramic substrate may be composed of a sintered body consisting mainly of aluminum oxide, aluminum nitride, silicon nitride, or the like or may be obtained by reinforcing these sintered bodies with fibers. The Si monocrystalline substrate, what is called a silicon wafer may have an oxide film on the surface thereof. An NiP layer may be formed on the surface of the metal substrate or nonmetal substrate by plating or sputtering.

The underlayer is provided to control the crystalinity and the grain size and to improve adhesion of the magnetic recording layer. The underlayer may be one used in a common magnetic recording media. The underlayer may be composed of a plurality of layers in order to efficiently accomplish the above objects. The underlayer may be metal, dielectric, or their mixture. The surface of the layer constituting the underlayer may be modified by ion irradiation, gas exposure, or the like.

The underlayer may also be a magnetic layer. In particular, if the magnetic recording layer is a perpendicular magnetization film used in a perpendicular magnetic recording apparatus, a soft underlayer (SUL) with a high permeability may be provided to construct what is called a perpendicular double-layer media having the perpendicular magnetic recording layer on the soft underlayer. In the perpendicular double-layer media, the soft underlayer shares a part of the function of the magnetic head (single-pole head) to pass the recording fields from the magnetic head magnetizing the perpendicular magnetic recording layer in a horizontal direction and to return the fields toward the magnetic head side. The soft underlayer can thus serve to apply steep, sufficient perpendicular fields to the magnetic recording layer to improve read/write efficiency.

The soft underlayer may be composed of a material containing Fe, Ni, or Co. Such a material may be an FeCo-based alloy, for example, FeCo or FeCoV, an FeNi-based alloy, for example, FeNi, FeNiMo, FeNiCr, or FeNiSi, an FeAl-based alloy, an FeSi-based alloy, for example, FeAl, FeAlSi, FeAlSiCr, FeAlSiTiRu, or FeAlO, an FeTa-based alloy, for example, FeTa, FeTaC, or FeTaN, or an FeZr-based alloy, for example, FeZrN.

The soft underlayer may also be composed of a material having a microcrystalline structure such as FeAlO, FeMgO, FeTaN, or FeZrN which contains at least 60 at % of Fe or a granular structure with fine crystal grains dispersed in a matrix.

The soft underlayer may also be composed of a Co alloy containing Co and at least one of Zr, Hf, Nb, Ta, Ti, and Y. The Co alloy preferably contains at least 80 at % of Co. If such a Co alloy is deposited by sputtering, an amorphous layer is easily formed. The amorphous soft magnetic material is free from magnetocrystalline anisotropy, crystal defects, and grain boundaries and thus exhibits a very excellent soft magnetism. The amorphous soft magnetic material enables to reduce media noise. Examples of preferable amorphous soft magnetic materials include, for example, CoZrO—, CoZrNb—, and CoZrTa-based alloys.

An underlayer may further be provided under SUL in order to improve crystallinity of SUL and adhesion of SUL to the substrate. A material for the underlayer may be Ti, Ta, W, Cr, Pt, or an alloy containing any of these elements, or their oxide or nitride.

An intermediate layer consisting of a nonmagnetic material may be provided between SUL and the recording layer as one of the plural layers constituting the underlayer. The intermediate layer plays two roles of isolating the exchange coupling interaction between SUL and the recording layer and controlling the crystallinity of the recording layer. A material for the intermediate layer may be Ru, Pt, Pd, W, Ti, Ta, Cr, Si, or an alloy containing any of these elements, or their oxide or nitride.

To prevent spike noise, SUL may be divided into plural layers with Ru of thickness 0.5 to 1.5 nm inserted between the layers for antiferromagnetic coupling. The soft magnetic layer may be exchange-coupled to a pinning layer consisting of a hard magnetic film such as CoCrPt, SmCo and FePt with in-plane anisotropy or an antiferromagnetic material such as IrMn and PtMn. In this case, to control exchange coupling force, magnetic films (for example, Co) or nonmagnetic films (for example, Pt) may be stacked on lower and upper surfaces of the Ru layer.

The magnetic recording layer may be a perpendicular magnetization film with the easy axis of magnetization aligned mainly in the direction perpendicular to the media plane or a longitudinal magnetization film with the easy axis of magnetization aligned in-plane. The magnetic recording layer preferably provides significant anisotropy when constituted by an alloy mainly composed of Co, for example, a CoPT alloy. The magnetic recording layer may be of a material containing an oxide. The oxide is preferably Co oxide, silicon oxide, titanium oxide, or an oxide of metal constituting the magnetic recording layer.

The magnetic recording layer may also be a so-called granular media in which magnetic grains (magnetic crystal grains) are dispersed. In particular, the linear recording density of the discrete track media is expected to be determined by a mechanism similar to that in the conventional media. Accordingly, the granular media is preferable, which is known to increase the linear recording density of the conventional media. For patterned media in a narrow sense, the linear recording density is determined by process accuracy. Consequently, a magnetic thin film of a microstructure that is not granular may also be used.

The magnetic recording layer may contain Co, Cr, Pt, an oxide, and at least one element selected from a group consisting of B, Ta, Mo, Cu, Nd, W, Nb, Sm, Tb, Ru, and Re. These elements enable reduction in magnetic grain size or improvement in crystallinity or orientation. This results in read/write characteristics and thermal fluctuation characteristics that are more suitable for high-density recording. The magnetic recording layer may also be a so-called magnetic artificial lattice in which a large number of layers of Co and rare metal such as Pt or Pd are stacked. An ordered alloy formed of Fe or Co and Pt or Pd may also be used.

The magnetic recording layer may have a multilayer structure. High-density recording can be accomplished by a magnetic recording layer composed of a stacked film of two or more magnetic layers having different magnetic characteristics. The magnetic recording layer may also be the entire stacked film composed of plural magnetic recording layers and plural nonmagnetic layers. For example, for longitudinal media, it is known that insertion of an Ru layer between plural magnetic layers makes it possible to induce ferromagnetic coupling to improve the linear recording density. This technique may thus be used.

The thickness of the magnetic recording layer is preferably between 2 and 60 nm, more preferably between 5 and 30 nm. This range makes the magnetic recording/reproducing apparatus more suitable for high-density recording. When the thickness of the magnetic recording layer is less than 2 nm, the level of reproduced output may be too low and lower than that of noise components. When the thickness of the magnetic recording layer is more than 60 nm, the level of reproduced output may be too high and distort waveforms.

The coersivity of the magnetic recording layer is preferably at least 237000 A/m (3000 Oe). A coersivity of less than 237000 A/m (3000 Oe) may degrade the thermal fluctuation characteristics.

The protective layer is provided in order to prevent corrosion of the magnetic recording layer and to prevent the media surface from being damaged when the magnetic head comes into contact with the media. A material for the protective layer may be a hard material, for example, C, Si—O, Zr—O, or Si—N. The thickness of the protective layer is preferably between 0.5 and 10 nm. This enables reduction in the distance between the head and the media and is thus suitable for high-density recording.

A lubricant layer may be provided on the protective layer. A lubricant used for the lubricant layer may be a well-known material, for example, perfluoropolyether, alcohol fluoride, or fluorinated carboxylic acid.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A patterned substrate used for a magnetic recording media having discrete tracks, comprising:
patterns of protrusions and recesses processed thereon, and
a texture structure formed on each of the recesses.

2. The substrate according to claim 1, wherein a texture structure is further formed on each of the protrusions.

3. The substrate according to claim 1, wherein a texture structure is formed on each of the protrusions, and wherein the texture structure on the recess has the same orientation as that of the texture structure on the protrusion.

4. The substrate according to claim 2, wherein the texture structure on the recess has a higher surface roughness Ra than that of the texture structure on the protrusion.

5. A magnetic recording media comprising:
the patterned substrate according to claim 1; and
a magnetic film deposited on the patterned substrate.

6. A magnetic recording apparatus comprising the magnetic recording media according to claim 5.

7. A method of manufacturing a patterned substrate, comprising:
forming a texture structure on each of the protrusions on a stamper having patterns of protrusions and recesses;
pressing the stamper against an imprint resist applied to a substrate to transfer the patterns of protrusions and recesses of the stamper and the texture structures on the protrusions to the imprint resist; and
etching the substrate using the imprint resist as a mask, to which the patterns and texture structures have been transferred, to form a patterned substrate having the patterns of protrusions and recesses formed on a surface thereof with the texture structure formed on each of the recesses.

8. A method of manufacturing a patterned substrate, comprising:
forming a texture structure on a surface of a master;
applying a resist to the master, drawing patterns of protrusions and recesses on the resist, and developing the resist to form a resist pattern having the protrusions and recesses;
etching the master using the resist pattern as a mask to form a patterned master having the patterns of protrusions and recesses formed thereon with the texture structure formed on each of the protrusions and recesses;
producing a first stamper from the master having the protrusions and recesses and producing a second stamper from the first stamper;
pressing the second stamper against an imprint resist applied to a substrate to transfer the patterns of protrusions and recesses of the second stamper and the texture structures on the protrusions and recesses to the imprint resist; and
etching the substrate using the imprint resist as a mask, to which the patterns and texture structures have been transferred, to form a patterned substrate having the patterns of protrusions and recesses formed on a surface thereof with the texture structure formed on each of the protrusions and recesses.
